(19) United States
(12) Patent Application Publication
(10) Pub. No.: US 2002/0100260 A1
(43) Pub. Date: Aug. 1, 2002

(54) Head gear for a horse

(76) Inventor: Elizabeth O' Neal, Fty. Myers, FL (US)

Correspondence Address: Elizabeth O' Neal, 12511 Shawnee Rd., Ft. Myers, FL, 33913, US

(21) Appl. No.: 09/771,266

(22) Filed: Jan. 29, 2001

(51) Int. Cl. B68B 1/04

(52) U.S. Cl. 54/6.1

(57) ABSTRACT

The invention is directed to a head gear for a horse in combination with a bridle that is placed on the horse's head. It is a headband to be worn by a horse on the forehead below the ears. The headband is made of a stiff but flexible material and includes a forwardly directed visor which will shade the horse's eyes. The head band has on each of its sides fabric extensions that have placed on their inner surfaces thereof hooks of a loop and hook fastener system. On an inner surface of said head band there is placed a strip of fabric having loops thereon of a loop and hook fastener system. In use, the fabric extensions are doubled back upon themselves so that the hooks of said extensions can engage the loops on said strip of fabric while at the same time surrounding each of the side bands of said bridle. The forward surface of the head band is useful for displaying logos thereon.

### REFERENCE TO MICROFICHE APPENDIX

(none)

### CROSS REFERENCE TO RELATED APPLICATIONS

(none)

### STATEMENT REGARDING FED SPONSORED R&D

(none)

### BACKGROUND TO THE INVENTION

The invention pertains to a head gear for a horse including a visor. The visor of the invention is more of a decorative or identifying nature rather than being functional such as to enhance the performance of the horse. There is a known visor for a horse wherein the stiffened forward part of the visor is attached to an hour glass-shaped piece of cloth that drapes upwardly whereby the narrow part of the hour glass shape passes between the narrow space of the horse's ears. A tunnel in the rear of the hour glass shaped fabric is used so that the top band of the bridle can pass there through. Further side extensions have Velcro™ thereon to double back over side bands of the bridle. This design of the known Horse Cap is quite cumbersome and difficult to install because the bridle has to be loosened in order to install the known “Horse Cap”. This Horse Cap is shown in a Journal named “Stable & Ranch”. The date is not known.

### BRIEF SUMMARY AND OBJECTS OF THE INVENTION

An object of the invention to construct a head gear for a horse that is simple to construct and it is easy to install on the horse's head. To this end the invention consists of a somewhat stiffened head band to which a forward visor is attached. On each side of the head band an extension is provided and each extension carries hook material that is fastened to loop material inside the head band.

### BRIEF DESCRIPTION OF THE DRAWINGS

FIG. 1 is a perspective view of the head gear for a horse;

FIG. 2 is a perspective and frontal view of the head gear installed on a bridle of a horse;

FIG. 3 is a perspective and rear view of the head gear installed on a bridle of a horse.

### DETAILED DESCRIPTION OF THE INVENTION

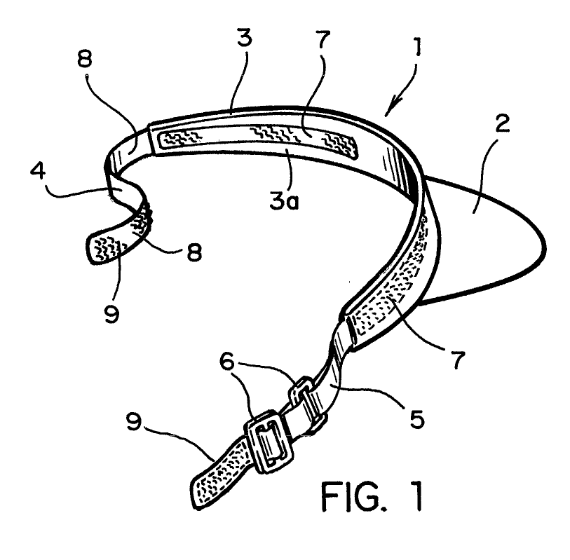

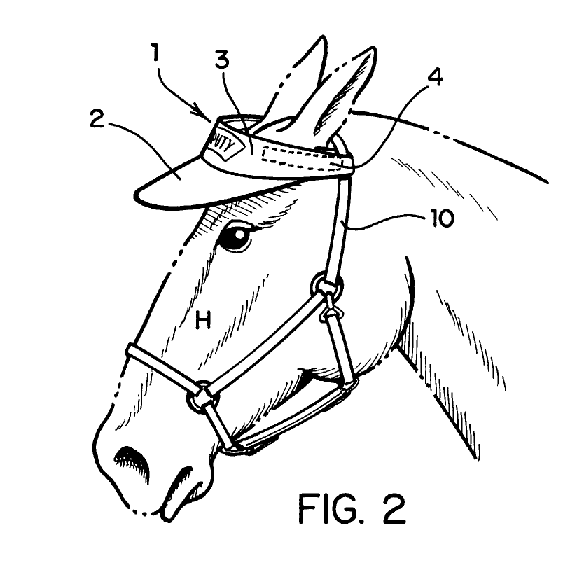

In FIG. 1 the head gear is shown as 1. The head gear consists of a forward visor 2 of a stiff but flexible material. The visor could be instrumental as a fly repellent when soaked with a water based fly repellent. The numeral 3 indicates a head band which also should be of a somewhat stiff material so that it will hold its shape on the left side of FIG. 1 there is shown a strip of fabric 4 as an extension of the head band and on the right side of FIG. 1 there is shown another strip of fabric 5 as an extension of the head band 3. On the extension 5, there is provided a buckle system 6 so that the head band 3 with its extension 5 can be adjusted to different head sizes of horses. On the inside 3a of the head band 3 there is shown a loop type fastener 7 of the well known VELCRO™ type fastener system. It is important that the loops be placed inside the head band 3a. If the hook type fastening strips were placed in this location, it would snag the hair of the horse's mane and would also be an irritant for the horse because of the presence of the hooks. The inside of the fabric extension carries the hook fasteners 8 which will engage the loops on the fastener 7. Also the head band extension 5 carries the hooks of the VELCRO™ fastening system to engage the loops on the fastening strip 7. The head gear of the invention cannot be placed on the head of a human because of the particular placement of the hooks and loops on the different elements. They could not engage with each other. Turning now to FIG. 2 there is shown the head gear 1 of the invention as it is installed the horse's head H. The same reference characters have been used as were shown in FIG. 1. To this end, there is shown a bridle band 10 which passes over the horse's head behind the ears to the other side. to install the head gear it is merely necessary to double back the extension 4 (in this example) on the bridle band 10 to engage the loops on the fastening strip 7 on the inside of the inside 3a of the head band 3 with the hooks present on the extension 4.

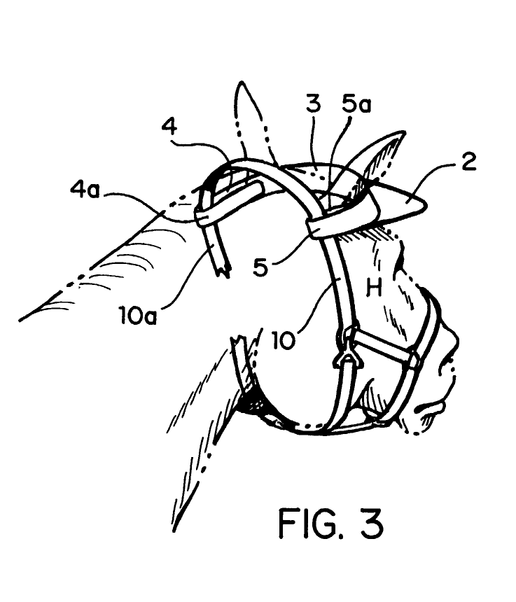

FIG. 3 shows a rear view of the installation of the head gear on a horse's head H. In this view both extensions 4 and 5 of the head band 3 can be seen. Also the doubled back portion 4a and the doubled back portion 5a can be seen on the extensions 4 and 5, respectively. Also the other bridle band 10a is shown to complete the view.

### SUMMARY OF THE INVENTION

In view of all of the above it is now clear that a novel head gear for a horse has been developed that can be used to display various logos. The head gear can be produced in various colors. The front of the head band above the visor can be used in a mounted patrol to display, for example, “Deputy”, “Police” or “Ranger”. “Volunteer” in various public functions. In carriage rides like “Tour Guide”. The forward visor could be instrumental in shading the eyes of the horse. The visor could also display logos such as “Party Animal” during public functions. The head gear can easily be installed and taken off. The head gear does not interfere with the horse's function or performance.

What I claim is:

1. A head gear for a horse in combination with a bridle on the horse's head, said bridle having side bands on each side of the horse's head, said head gear including a stiff but flexible head band having a forward visor thereon, said head band having on an inside surface, directed toward the horse's head, a strip of material having loops thereon of a hook- and loop type fastening system, said head band having on each side of said head band fabric extensions, each of said fabric extensions having on their inside surface hooks thereon of a hook- and loop fastening system, each of said fabric extensions being doubled back upon itself to engage said hooks with said loops on said strip of material while looping around on each of said side bands of said bridle.

2. The head gear of claim 1 including means for adjusting the length of one of said fabric extension.

3. The head gear of claim 1 including identifying logos on a front of said headband.
